(19) United States
(12) Patent Application Publication
(10) Pub. No.: US 2026/0319879 A1
(43) Pub. Date: Oct. 15, 2026

(54) SYSTEM, INFORMATION PROCESSING APPARATUS, AND INFORMATION PROCESSING METHOD

(71) Applicant: TOYOTA JIDOSHA KABUSHIKI KAISHA, Toyota-shi (TW)

(72) Inventor: Iwao NITTA, Nagoya-shi (JP)

(73) Assignee: TOYOTA JIDOSHA KABUSHIKI KAISHA, Toyota-shi (TW)

(21) Appl. No.: 19/325,696

(22) Filed: Sep. 11, 2025

(30) Foreign Application Priority Data
Sep. 20, 2024 (JP) 2024-164391

(51) Int. Cl. G06F 11/07

(52) U.S. Cl. CPC G06F 11/079; G06F 11/0709; G06F 11/0769

(57) ABSTRACT

Provided is a controller configured to perform: obtaining information on degradation corresponding to at least one of a unit of cell or a unit of module of a battery pack; and outputting information for displaying diagnostic information of the module according to the information on the degradation, for display corresponding to the pack and the module.

### CROSS REFERENCE TO THE RELATED APPLICATION

This application claims the benefit of Japanese Patent Application No. 2024-164391, filed on Sep. 20, 2024, which is hereby incorporated by reference herein in its entirety.

### BACKGROUND

### Technical Field

The present invention relates to a system, an information processing apparatus, and an information processing method.

### Description of the Related Art

There has been proposed a method for diagnosing the presence or absence of lithium metal deposition in a lithium ion battery by applying a high frequency current and observing a response (resistance value) of the lithium ion battery (see, for example, Non-Patent Literature 1).

### CITATION LIST

### Patent Literature

Non-Patent Document 1: Operando Li metal plating diagnostics via MHz band electromagnetics Nature Communications volume 14, Article number: 7275 (2023)

### SUMMARY

An object of the present invention is to provide information useful for reuse of a battery.

One aspect of the present invention is directed to a system including:
a diagnostic terminal configured to detect, by a sensor, information on degradation corresponding to at least one of a unit of cell or a unit of module of a battery pack;
a server including a controller configured to output information for displaying diagnostic information according to the information on the degradation; and
a user terminal;
wherein the diagnostic terminal transmits the information on the degradation to the server;
the controller is configured to perform:
   receiving the information on the degradation from the diagnostic terminal; and
   transmitting, to the user terminal, a command to display diagnostic information of the module according to the information on the degradation, for display corresponding to the pack and the module; and
in response to the command received from the server, the user terminal displays, on a display device, the diagnostic information of the module according to the information on the degradation, for display corresponding to the pack and the module.

Another aspect of the present invention is directed to an information processing apparatus including a controller configured to perform:
obtaining information on degradation corresponding to at least one of a unit of cell or a unit of module of a battery pack; and
outputting information for displaying diagnostic information of the module according to the information on the degradation, for display corresponding to the pack and the module.

A further aspect of the present invention is directed to an information processing method for causing a computer to perform:
obtaining information on degradation corresponding to at least one of a unit of cell or a unit of module of a battery pack; and
outputting information for displaying diagnostic information of the module according to the information on the degradation, for display corresponding to the pack and the module.

In addition, a still further aspect of the present invention is directed to a program for causing a computer to perform the information processing method, and a computer readable storage medium storing the program in a non-transitory manner.

According to the present invention, it is possible to provide information useful for reusing a battery.

### BRIEF DESCRIPTION OF THE DRAWINGS

FIG. 1 is a block diagram schematically illustrating an example of a configuration of each of a user terminal, a server, and a diagnostic terminal which together constitute a system according to a first embodiment;

FIG. 2 is a view illustrating a relationship between the frequency of current input to a battery and the response rates of a structure, an ionic component, and an electronic component;

FIG. 3 is a view illustrating a table configuration of a battery information DB;

FIG. 4 is a view illustrating an example of a screen displayed on a display device;

FIG. 5 is a view illustrating an example of a screen when a pop-up window is displayed in response to clicking or mouseover on a module box;

FIG. 6 is a view illustrating an example of a screen displaying details of cells;

FIG. 7 is a view illustrating an example of a graph of the distribution of the remaining capacity of each cell;

FIG. 8 is a sequence diagram illustrating an overall process of the system when information on the degradation of the battery is provided to the user terminal according to the first embodiment;

FIG. 9 is a flowchart illustrating a process in which a controller of the server collects battery information;

FIG. 10 is a flowchart illustrating a process in which the controller of the server generates degradation information according to the first embodiment;

FIG. 11 is a flowchart illustrating a process in which the controller of the server provides the degradation information to the user terminal;

FIG. 12 is a view illustrating an example of a screen when a pop-up window is displayed in response to clicking or mouseover on a module box according to a second embodiment; and

FIG. 13 is a flowchart illustrating a process in which a controller of a server according to the second embodiment generates degradation information.

### DESCRIPTION OF THE EMBODIMENTS

The present inventor has found the following problems. That is, a pack of a battery (hereinafter, also referred to a battery pack) is composed of a plurality of modules. Each module is composed of a plurality of cells. The entire pack of the battery are not necessarily used under the same conditions, such as different temperatures outside and inside a vehicle. This does not necessarily mean that the same degradation will occur in each module and each cell that constitute the same battery.

On the other hand, an information processing apparatus according to one aspect of the present disclosure includes a controller configured to perform: obtaining information on degradation corresponding to at least one of a unit of cell or a unit of module of a battery pack; and outputting information for displaying diagnostic information of the module according to the information on the degradation, for display corresponding to the pack and the module.

A battery is, for example, one that is installed in a vehicle. The battery has one or more packs, one pack has one or more modules (may be a stack), and one module has one or more cells. The information on the degradation includes, for example, information on the amount of lithium deposited and information on capacity. The information on the degradation is obtained on a cell or module basis. The display corresponding to packs and modules is a display with which a user can determine the number or arrangement of the packs and modules, and may be, for example, a display schematically representing the shape of the packs or modules. This display may be a display on a screen. The diagnostic information of a module includes, for example, information indicating whether or not the module has degraded, or whether or not at least one of the cells included in the modules has degraded. The information for displaying diagnostic information of the module is, for example, information for displaying, on the display corresponding to the pack and the module, that it is possible to determine that the pack and module have degraded. For example, the diagnostic information for the module may be displayed by assigning “!” to the display corresponding to the module. Then, the controller may output the information for displaying the diagnostic information of the module to a terminal of the user, for example. In addition, this information may also include a command to display the diagnostic information of the module on the user's terminal. In this way, the state of degradation of the module can be displayed, so that the user can easily know the state of degradation of the module.

The information on the degradation may include information on a resistance detected when the cell or the module is energized at a predetermined frequency. The predetermined frequency may be, for example, a frequency band in which a response rate of an electronic component is higher than a response rate of an ionic component and a response rate of an effect of a structure such as a terminal, or may be a frequency band in the vicinity thereof. By detecting the resistance in such a frequency band, it is possible to obtain a resistance value according to an amount of lithium deposition. Since the amount of lithium deposition correlates with the degradation of the cell or module, the state of degradation of the cell or module can be grasped more accurately by obtaining the resistance value. Then, the information on the resistance is displayed for the display corresponding to the pack and the module, so that the user can easily grasp the state of degradation of the battery.

The information on the degradation may include information on the capacity of the cell or the module. As the battery degrades, its chargeable or dischargeable capacity decreases. Thus, the information on the capacity of the cell or module correlates with the degradation of the battery. By obtaining such information, it is possible to detect the degradation of the battery. Then, by displaying such information for the display corresponding to the pack and the module, the user can easily grasp the state of degradation of the battery.

The information on the degradation may include information on the resistance detected when the cell or the module is energized at the predetermined frequency and information on the capacity of the cell or the module, and the controller may output information for displaying a warning corresponding to the information on the resistance and a warning corresponding to the information on the capacity, in different display modes. Here, the degree of importance to the user may differ between the degradation in which the capacity decreases and the degradation in which the resistance reduces. By warning them in different modes, the user can easily determine which one has a problem.

The controller may output information to be displayed in such a manner that the warning corresponding to the information on the resistance has a higher degree of warning than the warning corresponding to the information on the capacity. In some cases, the degradation in which the resistance reduces is more important than the degradation in which the capacity decreases. For example, if the amount of lithium deposition becomes too large, an internal short circuit will occur in the battery, making the battery unusable. On the other hand, even if the capacity reduces, the battery itself may still be usable. Therefore, by displaying the warning corresponding to the information on the resistance in such a manner that the degree of the warning becomes larger, it is possible to more reliably inform the user of the degradation in which the resistance has reduced. Note that the degree of the warning becoming larger means that the warning is more easily recognized by the user, and it may include making a color to be applied to the display of a warning mark more prominent, making the color to be applied to the display of the warning mark more alert (e.g., red), blinking the warning mark, making the display of the warning mark larger, or the like.

The information on the degradation may include the information on the resistance detected when the cell or the module is energized at the predetermined frequency and the information on the capacity of the cell or the module. The controller may output at least one of information for displaying the warning corresponding to the information on the resistance and information for displaying the warning corresponding to the information on the capacity. In addition, the controller may output, in the warning corresponding to the information on the resistance, information for displaying a stepwise warning according to a reduction in the resistance, or may output, in the warning corresponding to the information on the capacity, information for displaying a stepwise warning according to a decrease in the capacity. Displaying stepwise warnings includes, for example, providing a plurality of threshold values in a stepwise manner so as to display which stage the degradation state is in. In this way, by displaying stepwise warnings, the user can know the degree of degradation.

In addition, the information on the degradation may include information on degradation corresponding to a unit of cells of the pack, and the controller may further output information for displaying diagnostic information of each of a plurality of cells included in the module selected for display corresponding to the pack and the module. By obtaining the information on degradation on a cell basis, it is possible to determine the degradation in each cell. Also, the controller determines whether or not the module includes a degraded cell, thus making it possible to determine degradation in the module. By displaying the module degradation and the cell degradation in this manner, the user can determine at a glance which module or cell is available.

Hereinafter, embodiments of the present invention will be described based on the accompanying drawings. The configurations of the following embodiments are examples, and the present invention is not limited to the configurations of the embodiments. In addition, the following embodiments can be combined with one another as long as such combinations are possible and appropriate.

### First Embodiment

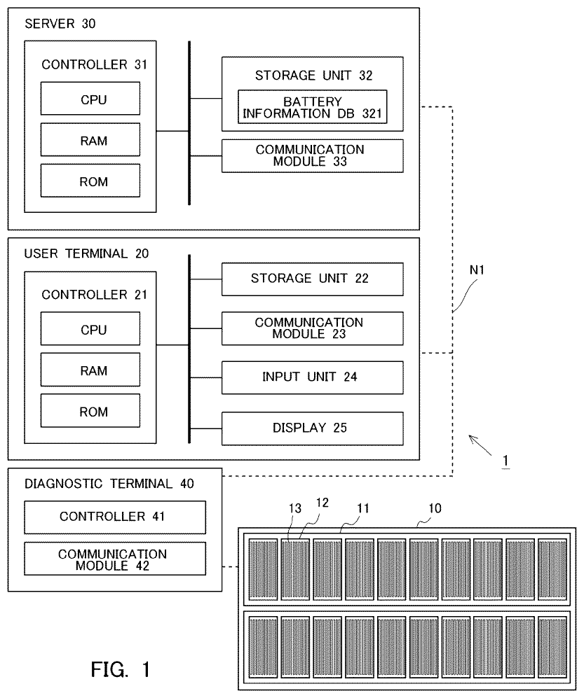

FIG. 1 is a block diagram schematically illustrating an example of the configuration of each of a user terminal 20, a server 30 and a diagnostic terminal 40, which together constitute a system 1 according to the present embodiment. In the example of FIG. 1, the system 1 includes the user terminal 20, the server 30 and the diagnostic terminal 40. The user terminal 20 is, for example, a terminal used by a user who browses the diagnostic result of a battery 10. The diagnostic terminal 40 is a terminal that detects the state of degradation of the battery 10 and provides the detection result to the server 30. The server 30 is a server that provides the user terminal 20 with information on the state of degradation of the battery 10 collected from the diagnostic terminal 40.

The user terminal 20, the server 30 and the diagnostic terminal 40 are connected to one another by a network N1. Here, note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like.

The battery 10 is, for example, a secondary battery installed on a battery electric vehicle (BEV), a plug-in hybrid electric vehicle (PHEV), a hybrid electric vehicle (HEV), or the like, and is, for example, a lithium ion battery (LiB). Note that the battery 10 has, for example, two packs 11. One pack 11 has, for example, ten modules 12 (which may be called a stack). One module 12 has, for example, ten cells 13. Therefore, in the example illustrated in FIG. 1, the battery 10 has 200 cells 13. Note that the number of packs 11, modules 12, and cells 13 included in one battery 10 is not limited to the example illustrated in FIG. 1, but can be set optionally.

The diagnostic terminal 40 is configured to include a controller 41 and a communication module 42. The diagnostic terminal 40 can be configured as a computer including a processor (a CPU, a GPU, or the like), a main storage device (a RAM, a ROM, or the like), and an auxiliary storage device (an EPROM, a hard disk drive, a removable medium, or the like). The controller 41 is an arithmetic unit that realizes various functions of the diagnostic terminal 40 by executing a predetermined program. The controller 41 can be realized by a hardware processor such as, for example, a CPU or the like. In addition, the controller 41 may be configured to include a RAM, a ROM, a cache memory, and the like. The communication module 42 is a communication interface for connecting the diagnostic terminal 40 to the network N1. The diagnostic terminal 40 may include an input device such as a mouse, a keyboard or the like, and an output device such as an LCD, an EL panel or the like.

The controller 41 of the diagnostic terminal 40 measures the resistance value and the capacity of the battery 10 as information on the degradation of the battery 10. The resistance value of the battery 10 is a value related to the amount of lithium deposited in the battery 10. In the case of the lithium ion battery, when an excessive stress is applied to the battery 10 due to quick charging or the like, lithium ions inside the battery 10 may be deposited on the surface of a negative electrode. The deposition of lithium may not only reduce the capacity and output of the battery 10 but also cause an internal short circuit in the battery 10. Therefore, when the lithium ion battery is reused, it is important to diagnose not only its degradation state related to its capacity but also the amount of lithium deposition. In this way, the amount of lithium deposition serves as an index of degradation of the battery 10.

The larger the amount of lithium deposited in the battery 10, the easier it is for current to flow, and the lower the internal resistance of the battery 10. Therefore, by detecting the resistance of battery 10, the degree of degradation due to the deposition of lithium can be detected. The resistance of the battery 10 can be detected by, for example, a Magnified Metal Object Response Inspecting Sensor (MaMoRiS (registered trademark)) or Electro-chemical Impedance Spectroscopy (EIS). Note that other known techniques can also be used to detect the resistance of the battery 10.

The MaMoRiS (registered trademark) sets a measurement frequency to a higher frequency band and detects resistance from the response of a high frequency current as compared with the conventional electrochemical impedance spectroscopy. The MaMoRiS (registered trademark) focuses not on the movement of lithium ions, but on the movement of electrons, which has a direct impact on changes in the properties of metallic materials. Here, there is known a phenomenon called a skin effect in which, when a high frequency current flows through a conductor, the current concentrates on the surface of the conductor. When lithium is deposited on the surface of the negative electrode of the battery 10, current flows more easily in the high frequency band, so that the resistance of the battery 10 reduces. This phenomenon can be utilized to detect lithium deposited on the surface of the negative electrode.

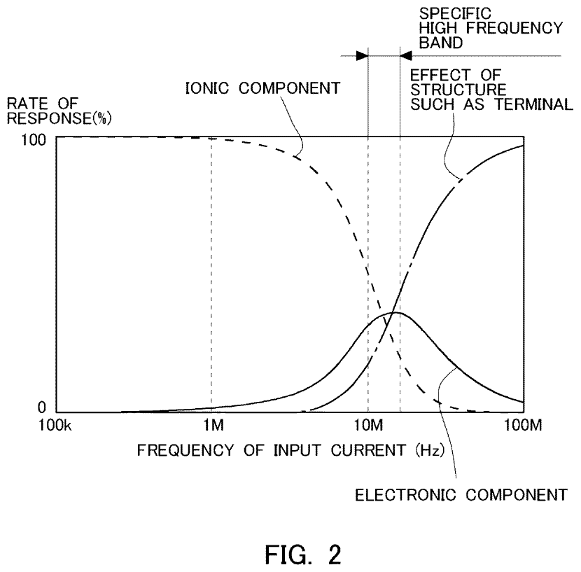

FIG. 2 is a view illustrating a relationship between the frequency of current input to the battery 10 and the response rates of a structure, an ionic component, and an electronic component. Here, in a certain high frequency band (i.e., a frequency band around 10 MHz), the rate (percentage) of the response of the ionic component and the rate of the response of the effect of the structure are lower than the rate of the response of the electronic component. That is, in a specific high frequency band, the movement of ions and the effect of the structure such as a terminal are small, and hence the movement of electrons inside the battery 10 can be captured with emphasis. In this specific high frequency band, the more the amount of lithium deposited on the negative electrode surface, the internal resistance of the battery 10 changes in a direction in which electrons are more likely to flow. By grasping this change in the resistance value, the amount of lithium deposition can be detected non-destructively and in real time.

The controller 41 of the diagnostic terminal 40 detects the resistance value of the battery 10 in the specific high frequency band. The specific high frequency band may be, for example, a frequency band in which the response rate of the electronic component is higher than the response rate of the ionic component and the response rate of the effect of the structure, and may be a frequency band in the vicinity thereof. The specific high frequency band is an example of the predetermined frequency.

In addition, the capacity of the battery 10 may be reduced due to various factors. The performance of the battery 10 is reduced due to the reduction in the capacity of the battery 10, and thus the capacity of the battery 10 serves as an index of the degradation of the battery 10. The controller 41 of the diagnostic terminal 40 detects the capacity of the battery 10 based on the current and time when the battery 10 is discharged. At this time, the controller 41 of the diagnostic terminal 40 fully charges the battery 10, and then measures the current while discharging it. The controller 41 calculates the capacity (Ah) of the battery 10 by integrating the current during discharging. Note that the method of measuring the capacity of the battery 10 is not limited to this. As another example, the controller 41 may detect the capacity (Ah) of the battery 10 by measuring and integrating the current while charging the battery 10 after discharge thereof.

The controller 41 of the diagnostic terminal 40 may provide the resistance value and the capacity thus detected to the server 30, or may calculate a reduction rate of resistance and a remaining capacity to provide them to the server 30. The resistance reduction rate is a value indicating how much the resistance value has reduced relative to a reference resistance value of the battery 10. That is, the resistance reduction rate is a value indicating the degree of reduction in the resistance of the battery 10 from the reference value. The resistance reduction rate is calculated as a ratio of a reduced resistance value to the reference resistance value of the battery 10. The reduced resistance value is a value obtained by subtracting the detected resistance value from the reference resistance value of the battery 10. The reference value is a resistance value at the time when the battery 10 is new or certified. Note that, similar to the reduction rate of resistance, a reduction amount of resistance correlates with the amount of lithium deposition. The resistance reduction amount is a value obtained by subtracting the detected resistance value from the reference resistance value of the battery 10. Therefore, the controller 41 may provide the resistance reduction amount to the server 30. In addition, the remaining capacity is calculated as a ratio of the detected capacity to a reference value of the capacity of the battery 10. The reference value is the capacity of the battery 10 at the time when it is new or certified. The controller 41 can detect the resistance value and the capacity of the battery 10 on a cell or module basis. In this case, a user who performs diagnosis attaches a sensor to each cell or each module. A detection value of each sensor is input to the diagnostic terminal 40. For example, the controller 41 associates the information on the resistance value of each cell and the information on the capacity of each cell with the battery ID, and transmits them to the server 30 as diagnostic results.

The server 30 provides the information on the degradation of the battery 10 in a form that is easy for the user to view. The server 30 includes a controller 31, a storage unit 32, and a communication module 33. The server 30 can be configured as a computer including a processor (a CPU, a GPU, or the like), a main storage device (a RAM, a ROM, or the like), and an auxiliary storage device (an EPROM, a hard disk drive, a removable medium, or the like). An operating system (OS), various programs, various tables, etc., are stored in the auxiliary storage device, and by executing the programs stored therein, it is possible to realize each function (software module) that meets a predetermined purpose, as described later. However, some or all of the modules may be realized as a hardware module by a hardware circuit such as, for example, an ASIC, a FPGA or the like.

The controller 31 is an arithmetic unit that realizes the various functions of the server 30 by executing a predetermined program. The controller 31 can be realized by a hardware processor such as, for example, a CPU or the like. In addition, the controller 31 may be configured to include a RAM, a ROM, a cache memory, and the like. Details of the controller 31 will be described later.

The storage unit 32 is a means or unit for storing information, and is constituted by a storage medium such as a RAM, a magnetic disk, a flash memory or the like. The storage unit 32 stores programs to be executed by the controller 31, data to be used by the programs, etc. Also, a database (battery information DB 321) is built in the storage unit 32, and information on the battery 10 collected from the diagnostic terminal 40 and information on the battery 10 calculated by the controller 31 of the server 30 are stored in the database.

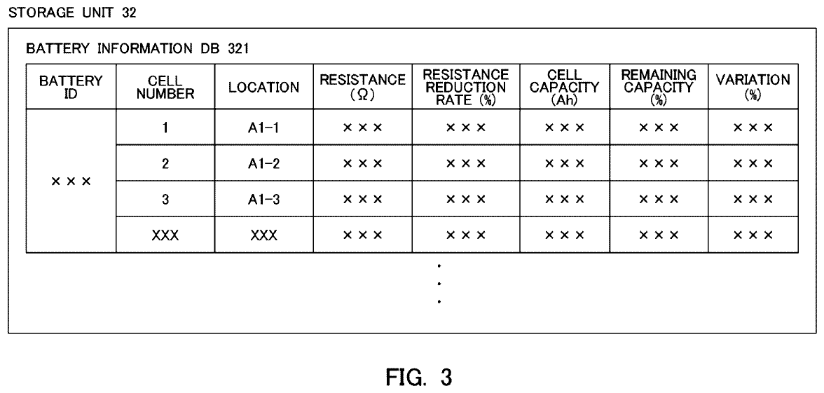

FIG. 3 is a diagram illustrating a table structure of the battery information DB 321. The battery information DB 321 has respective fields for battery ID, cell number, location, resistance, resistance reduction rate, cell capacity, remaining capacity, and variation. The battery ID field stores identification information unique to the battery 10. The cell number field stores information on a number corresponding to each cell included in the battery 10. In the location field, information on a location where each cell is arranged is stored. In the location field, for example, information capable of determining at which position of which module each cell is arranged is stored. In the resistance field, information on the internal resistance (Ω) of each cell at the time of diagnosis is stored. In the resistance reduction rate field, information on the ratio (%) of the reduced resistance value to a reference resistance value of each cell is stored. The reduced resistance value is a value obtained by subtracting the detected resistance value from the reference resistance value of each cell. The reference value is a resistance value at the time when each cell is new or certified. Note that when information on the resistance reduction rate is transmitted from the diagnostic terminal 40 to the server 30, the resistance field may be omitted. In the cell capacity field, information on the capacity (Ah) of each cell at the time of diagnosis is stored. In the remaining capacity field, information on the ratio (%) of the cell capacity at the time of diagnosis to a reference cell capacity is stored. The reference cell capacity may be a cell capacity at the time when the battery 10 is new or certified. In addition, information stored in the remaining capacity field may be information on a state of health (SOH) or a state of certified energy (SoCE). In the variation field, information on the ratio (%) of the remaining capacity of each cell to an average value of the remaining capacities of all the cells included in the same battery ID is stored. That is, the variation field stores information that allows the user to determine how much the remaining capacity of each cell deviates from the average value.

All of the information stored in the battery information DB 321 may be obtained from the diagnostic terminal 40, or data necessary for calculation may be obtained from the diagnostic terminal 40 and calculated by the controller 31 based on the data.

The communication module 33 is a communication interface for connecting the server 30 to the network N1. The communication module 33 may be configured to include, for example, a network interface board, a wireless communication interface for wireless communication, and the like. The server 30 can perform data communication with the user terminal 20 and the diagnostic terminal 40 via the communication module 33.

Note that, in a specific hardware configuration of the server 30, components can be omitted, replaced, or added as appropriate, depending on the implementation.

The user terminal 20 is, for example, a terminal used by a business operator who reuses the battery 10. The user registers in advance with the server 30 via the user terminal 20. The user terminal 20 can access the server 30 to obtain information on the degradation of a used battery 10. Thus, the user can search for a battery 10 in a degraded state that matches the intended use of the battery 10.

The user terminal 20 is configured to include a controller 21, a storage unit 22, a communication module 23, an input unit 24, and a display device 25. The controller 21 is an arithmetic unit that realizes various functions of the user terminal 20 by executing a predetermined program. The controller 21 can be realized by a hardware processor such as, for example, a CPU or the like. In addition, the controller 21 may be configured to include a RAM, a ROM, a cache memory, and the like. The storage unit 22 is a means or unit for storing information, and is constituted by a storage medium such as a RAM, a magnetic disk, a flash memory or the like. The storage unit 22 stores programs to be executed by the controller 21, data to be used by the programs, etc. The communication module 23 is a communication means or unit for connecting the user terminal 20 to the network N1, and has the same configuration as the communication module 33 of the server 30.

The input unit 24 is a means or unit that accepts an input operation performed by the user. The input unit 24 includes a device for input such as a mouse, a keyboard or the like. The display device 25 is a means or unit for presenting information to the user, and includes, for example, a liquid crystal display (LCD), an electroluminescence (EL) panel, or the like. The input unit 24 and the display device 25 may be configured as a single touch screen.

The controller 21 of the user terminal 20 accesses the server 30 in response to a predetermined input from the user to the input unit 24, and obtains information on the degradation of the battery (hereinafter, also referred to as degradation information). The controller 21 displays the degradation information thus obtained on the display device 25. The controller 21 of the user terminal 20 can display information on a state of safety (SOS) on the display device 25 as the degradation information.

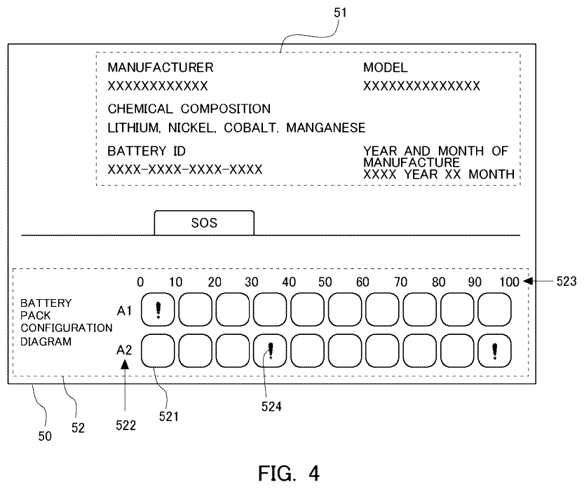

FIG. 4 is a view illustrating an example of a screen 50 displayed on the display device 25. The information necessary for displaying the screen 50 on the display device 25 is transmitted from the server 30 to the user terminal 20. In the upper portion of the screen 50, there is displayed a column 51 indicating the manufacturer, the model, the chemical composition, the battery ID, and the year and month of manufacture, of the battery 10. Below this column 51, a configuration diagram 52 of a battery pack is displayed. In the configuration diagram 52 of the battery pack, one module corresponds to one box 521, and boxes 521 are arranged in the same number as the modules. Note that a box 521 corresponding to a module is hereinafter also referred to as a module box 521. In the example illustrated in FIG. 4, ten modules arranged in the horizontal direction indicate a group of modules connected in series, for example. Thus, groups of series-connected modules are designated as A1 and A2 (reference sign 522). The modules A1 and A2 are connected in parallel, for example. Also, in the example illustrated in FIG. 4, one module includes ten cells, and the number of cells is shown above each of the module boxes 521 in the top row (reference sign 523). In addition, alerts 524 for warning are displayed in the module boxes 521 corresponding to the modules that each includes a cell of which the resistance reduction rate is equal to or greater than a resistance reduction rate threshold value or the remaining capacity is equal to or less than a remaining capacity threshold value. In the example illustrated in FIG. 4, the alerts 524 are displayed for the first module box 521 from the left of the module group of A1, the fourth module box 521 from the left of the module group of A2, and the tenth module box 521 from the left of the module group of A2.

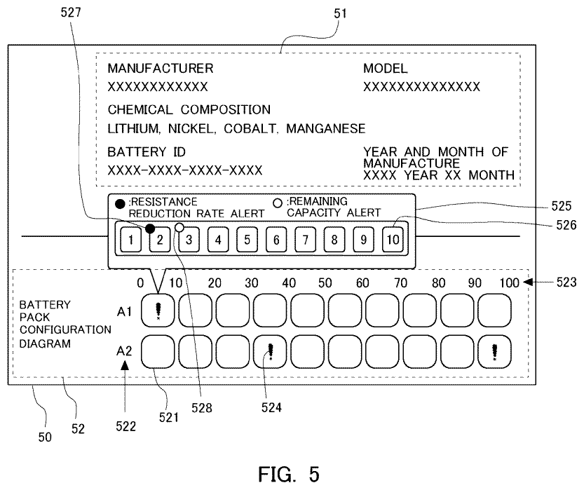

Here, when the user clicks or mouses over a module box 521 in which an alert 524 is displayed using the input unit 24, the details of the alert 524 are displayed in a pop-up window. FIG. 5 is a view illustrating an example of the screen 50 when a pop-up window 525 is displayed in response to clicking or mouseover on an alerted module box 521. The information necessary for displaying the pop-up window 525 on the display device 25 is transmitted from the server 30 to the user terminal 20. In the pop-up window 525, boxes 526 corresponding to the cells constituting the module are displayed. Hereinafter, a box 526 corresponding to a cell is also referred to as a cell box 526. Each cell box 526 is numbered. In the example illustrated in FIG. 5, ten cells are arranged in one module, and thus ten cell boxes 526 are displayed. For example, a red circle is displayed in the cell box 526 corresponding to a cell of which the resistance reduction rate is equal to or greater than the resistance reduction rate threshold value, and a yellow circle is displayed in the cell box 526 corresponding to a cell of which the remaining capacity is equal to or less than the remaining capacity threshold value. For example, a circular mark given to the cell box 526 corresponding to a cell of which the resistance reduction rate is equal to or greater than the resistance reduction rate threshold value is hereinafter also referred to as a resistance reduction rate alert mark 527, and a circular mark given to the cell box 526 corresponding to a cell of which the remaining capacity is equal to or less than the remaining capacity threshold value is also referred to as a remaining capacity alert mark 528. The resistance reduction rate threshold value is a value obtained by adding a certain margin to the resistance reduction rate when the amount of lithium deposited exceeds a limit. The resistance reduction rate threshold value may be, for example, a resistance reduction rate at which an internal short circuit is likely to occur. Also, the resistance reduction rate threshold value may vary depending on the model of the battery 10. In addition, the remaining capacity threshold value may be a lower limit value of an allowable remaining capacity. This remaining capacity threshold value may be optionally determined. Further, the remaining capacity threshold value may vary depending on the model of the battery 10. Note that an increase in the resistance reduction rate may be considered more important, as an index of degradation of the battery 10, than a reduction in the remaining capacity, a warning that the resistance reduction rate is equal to or greater than the resistance reduction rate threshold value may be displayed more prominently or in a more warning color than a warning that the remaining capacity is equal to or less than the remaining capacity threshold value. For example, a cell of which the resistance reduction rate is equal to or greater than the resistance reduction rate threshold value may be prominently displayed with a red circle, and a cell of which the remaining capacity is equal to or less than the remaining capacity threshold value may be displayed with a yellow circle. In this manner, the degree of warning for the increase in the resistance reduction rate may be displayed to be larger than the degree of warning for the reduction in the remaining capacity. In addition, for example, a larger mark may be displayed for a cell having its resistance reduction rate equal to or greater than the resistance reduction rate threshold value than for a cell having its remaining capacity equal to or less than the remaining capacity threshold value. Also, for example, a green circle indicating that there is no problem may be displayed in the cell box 526 corresponding to a cell of which the resistance reduction rate is less than the resistance reduction rate threshold value and the remaining capacity is greater than the remaining capacity threshold value. Further, as another example, the same mark may be given to the cell box 526 corresponding to a cell of which the resistance reduction rate is equal to or greater than the resistance reduction rate threshold value, and the cell box 526 corresponding to a cell of which the remaining capacity is equal to or less than the remaining capacity threshold value.

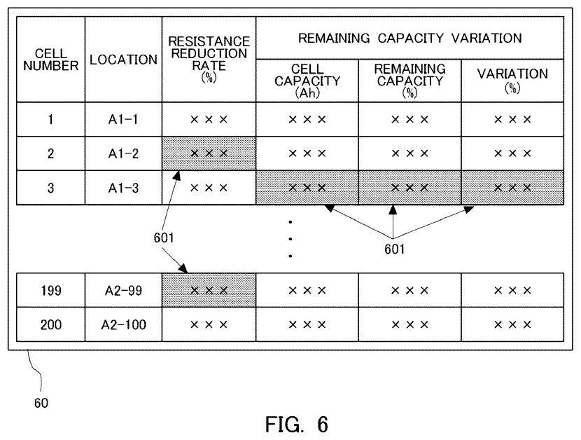

In addition, the controller 21 can also obtain the details of the resistance reduction rate and the remaining capacity of each cell from the server 30 and display the details on the display device 25. FIG. 6 is a view illustrating an example of a screen 60 displaying details of the cells. The information necessary for displaying the screen 60 on the display device 25 is transmitted from the server 30 to the user terminal 20. The screen 60 displaying the details of the cells may be displayed below the configuration diagram 52 of the battery pack. For example, the screen 60 may appear by scrolling the screen 50. The screen 60 displaying the details of the cells displays the cell number, the location, the resistance reduction rate (%), and the remaining capacity variation, which correspond to each cell. The remaining capacity variation includes the cell capacity (Ah), the remaining capacity (%), and the variation (%) of each cell. These correspond to the information stored in the battery information DB 321. The controller 21 obtains information for displaying the screen 60 from the server 30 to display the screen 60. Also, portions where the resistance reduction rate is equal to or greater than the resistance reduction rate threshold value and portions where the remaining capacity is equal to or less than the remaining capacity threshold value are colored differently from the other portions so that they stand out. In FIG. 6, the portions that are colored differently from the other portions are indicated by reference sign 601. The screen illustrated in FIG. 6 is configured to be scrollable, allowing the user to scroll to see the details of the cell corresponding to a cell number.

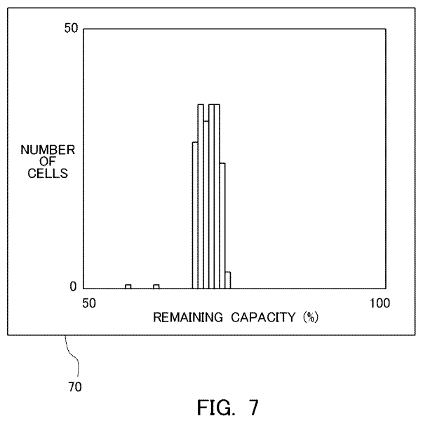

Moreover, the controller 21 can also display on the display device 25 a screen 70 that shows the distribution of the remaining capacity of each cell as a graph. FIG. 7 is a view illustrating an example of a graph of the distribution of the remaining capacity of each cell. The information necessary for displaying the screen 70 on the display device 25 is transmitted from the server 30 to the user terminal 20. The horizontal axis represents the remaining capacity (%), and the vertical axis represents the number of cells. FIG. 7 illustrates the distribution of the remaining capacities of all the cells included in one battery 10. The graph illustrated in FIG. 7 may be displayed on the right side of the screen 60 displaying the details of the cells illustrated in FIG. 6.

Next, the controller 31 of the server 30 will be described in detail. The controller 31 of the server 30 receives information on the resistance of each cell and the capacity of each cell from the diagnostic terminal 40. Further, the controller 31 calculates the resistance reduction rate of each cell and the remaining capacity of each cell. This resistance reduction rate is a ratio (%) of the reduction amount of the resistance value of each cell at the time of diagnosis to the reference resistance value of the cell. The reference value is the resistance value of each cell at the time when the cell is new or certified. The reduction amount of the cell resistance value at the time of diagnosis is a value obtained by subtracting the cell resistance value at the time of diagnosis from the reference value of the cell resistance value. In addition, the remaining capacity is a ratio (%) of the capacity of each cell at the time of diagnosis to the capacity of each cell at the time when the cell is new or certified. The resistance and capacity of each cell at the time when the cell is new or certified are provided from an external server of, for example, a manufacturer of the cell or a manufacturer of a vehicle on which the battery 10 is installed, and are stored in the storage unit 32. Note that, as another example, the controller 41 of the diagnostic terminal 40 may calculate the resistance reduction rate and the remaining capacity of each cell and transmit them to the server 30. Also, the controller 41 calculates a variation in the remaining capacity (%) of each cell. The variation is a ratio of the remaining capacity calculated for each cell to the average value of the remaining capacities of all the cells included in the battery 10. That is, the variation is a value that indicates how far the remaining capacity varies from the average value for each cell.

The controller 31 of the server 30 stores the cell resistance, the cell capacity, the calculated resistance reduction rate, the calculated remaining capacity, and the variation obtained from the diagnostic terminal 40 for each cell in the battery information DB 321.

In addition, the controller 31 generates the screen 50 illustrated in FIG. 4 based on the information stored in the battery information DB 321. This generation may be triggered by a request from the user terminal 20 or by information being stored in the battery information DB 321. The column 51 displayed on the screen 50 is a column in which information associated with the battery ID stored in the battery information DB 321 is displayed. The information displayed in the column 51 is stored in the storage unit 32 in association with the battery ID. The controller 31 identifies cells of which the resistance reduction rate is equal to or greater than the resistance reduction rate threshold value and cells of which the remaining capacity is equal to or less than the remaining capacity threshold value. Further, the controller 31 identifies modules including at least one of the cells of which the resistance reduction rate is equal to or greater than the resistance reduction rate threshold value and the cells of which the remaining capacity is equal to or less than the remaining capacity threshold value. At this time, the modules identified by the controller 31 are hereinafter referred to as “warning modules”.

When generating the screen 50, the controller 31 generates the configuration diagram 52 of the battery pack. The controller 31 arranges the module boxes 521 in the configuration diagram 52 of the battery pack in such a manner that the modules connected in series are arranged in the horizontal direction and the modules connected in parallel are arranged in the vertical direction. In addition, as indicated by reference sign 523 in FIG. 4, the controller 31 generates the configuration diagram 52 in such a manner that the number of cells corresponding to each module is displayed above the module box 521. Also, as indicated by reference sign 522 in FIG. 4, the controller 31 generates the configuration diagram 52 in such a manner that symbols corresponding to the respective module groups are displayed on the left side of the respective module groups. Further, the module boxes 521 corresponding to the warning modules are each displayed with an alert 524 attached thereto. In this way, the controller 31 generates the configuration diagram 52 of the battery pack.

Moreover, the controller 31 generates the pop-up window 525 illustrated in FIG. 5. The timing for generating the pop-up window 525 may be when the configuration diagram 52 of the battery pack is generated, or when the screen 50 is displayed on the user terminal 20, or when a warning module is clicked or moused over at the user terminal 20. The controller 31 displays the cell boxes 526 as many as the number of cells included in each warning module in the horizontal direction. Note that when it is difficult to display all the cell boxes 526 in one row in the horizontal direction due to a large number of cells, a plurality of rows may be generated in the vertical direction to arrange the cell boxes 526. The controller 31 causes the respective cell boxes 526 to display numbers in sequence. In addition, the controller 31 identifies each of the cells of which the resistance reduction rate is equal to or greater than the resistance reduction rate threshold value and each of the cells of which the remaining capacity is equal to or less than the remaining capacity threshold value, and attaches the resistance reduction rate alert mark 527 or the remaining capacity alert mark 528 to the upper left of the corresponding cell box 526. Note that for the cell box 526 corresponding to a cell of which the resistance reduction rate is equal to or greater than the resistance reduction rate threshold value and of which the remaining capacity is equal to or less than the remaining capacity threshold value, both of the marks may be attached side by side, or only the resistance reduction rate alert mark 527 having a higher degree of importance may be attached preferentially. Also, note that the pop-up window 525 may be displayed in response to clicking or mouseover of a module box 521 in which an alert 524 is not displayed. The pop-up window 525 displayed at this time may display the cell boxes 526 to which the resistance reduction rate alert mark 527 and the remaining capacity alert mark 528 are not attached. The resistance reduction rate alert mark 527 is an example of a warning corresponding to the information on the resistance, and the remaining capacity alert mark 528 is an example of a warning corresponding to the information on the capacity.

The controller 31 may display the resistance reduction rate alert mark 527 and the remaining capacity alert mark 528 in such a manner that a warning for the resistance reduction rate equal to or greater than the resistance reduction rate threshold value is displayed more prominently or in a more warning color than a warning for the remaining capacity equal to or less than the remaining capacity threshold value. In this way, the controller 31 displays the resistance reduction rate alert mark 527 and the remaining capacity alert mark 528 so that the degree of warning for an increase in the resistance reduction rate is larger than the degree of warning for a reduction in the remaining capacity. Note that the controller 31 may display a green circle indicating that there is no problem in the cell box 526 corresponding to a cell of which the resistance reduction rate is less than the resistance reduction rate threshold value and the remaining capacity is greater than the remaining capacity threshold value. In addition, as another example, the controller 31 may give the same mark to the cell box 526 corresponding to a cell having the resistance reduction rate equal to or greater than the resistance reduction rate threshold value and the cell box 526 corresponding to a cell having the remaining capacity equal to or less than the remaining capacity threshold value.

In addition, the controller 31 generates the screen 60 for displaying the details of the cells. The controller 31 generates the screen 60 in such a manner that information stored in the battery information DB 321 is displayed on the screen 60. Further, the screen 60 is generated so that the display portions for the resistance reduction rate corresponding to cells of which the resistance reduction rate is equal to or greater than the resistance reduction rate threshold value and the display portions for the cell capacity, the remaining capacity, and the variation corresponding to cells of which the remaining capacity is equal to or less than the remaining capacity threshold value are displayed in colors different from other portions.

Further, the controller 31 generates the screen 70 for displaying a graph. The number of cells corresponding to each remaining capacity on the horizontal axis of the graph is counted from the remaining capacity field of the battery information DB 321 to generate the screen 70. Note that the number of cells for each module may be transmitted from the diagnostic terminal 40.

The controller 31 transmits information for displaying the screen 50, the screen 60, and the screen 70 to the user terminal 20 in response to a request from the user terminal 20. At this time, the controller 31 may transmit a command for displaying the screen 50, the screen 60, and the screen 70 on the display device 25 of the user terminal 20 to the user terminal 20. In addition, in response to the module box 521 corresponding to a warning module being clicked or moused over on the screen 50, the controller 31 transmits information for displaying the pop-up window 525 to the user terminal 20. The controller 31 may transmit the information for displaying the pop-up window 525 to the user terminal 20 together with the information for displaying the screen 50. The controller 31 may transmit, to the user terminal 20, a command to display the pop-up window 525 on the display device 25 of the user terminal 20 in response to the module box 521 corresponding to the warning module being clicked or moused over.

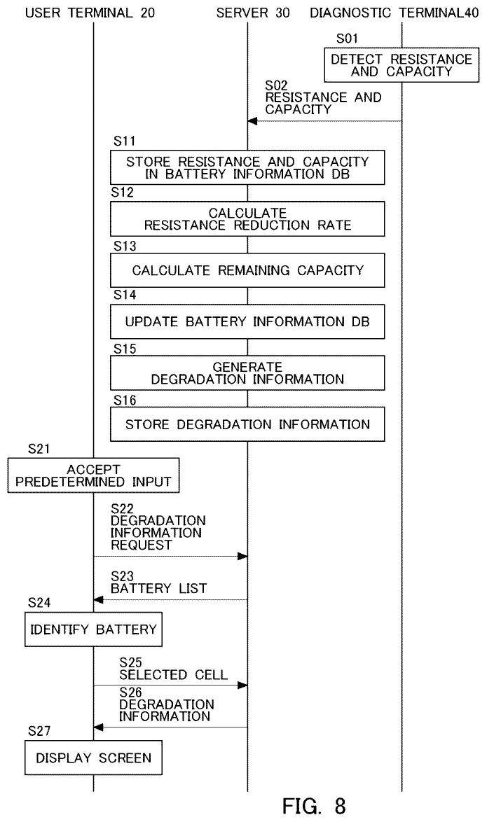

FIG. 8 is a sequence diagram illustrating the overall processing of the system 1 when the information on the degradation of the battery 10 is provided to the user terminal 20 according to the first embodiment. First, the controller 41 of the diagnostic device 40 detects the resistance and capacity of each cell of the battery 10 (S01). The controller 41 transmits the detected resistance and capacity of each cell to the server 30 in association with the battery ID together with the cell number and the location of the cell (S02).

The controller 31 of the server 30 stores the resistance and capacity of each cell received from the diagnostic terminal 40 in the battery information DB 321 (S11). The controller 31 calculates the resistance reduction rate of each cell based on the resistance of each cell (S12). Further, the controller 31 calculates the remaining capacity of each cell based on the capacity of each cell (S13). The controller 31 updates the battery information DB 321 by storing the calculated resistance reduction rate and remaining capacity of each cell in the battery information DB 321 (S14). In addition, the controller 31 generates degradation information based on the information stored in the battery information DB 321 (S15). The degradation information is information for displaying the screen 50 shown in FIG. 4, the pop-up window 525 shown in FIG. 5, the screen 60 shown in FIG. 6, and the screen 70 shown in FIG. 7 on the user terminal 20. The degradation information is an example of information for displaying diagnostic information. After generating the degradation information, the controller 31 stores the degradation information in the storage unit 32 in association with the battery ID (S16).

The controller 21 of the user terminal 20 accepts a predetermined input from the user to view the degradation information of the battery 10 (S21). For example, when the user activates predetermined application software for displaying the screen 50 or the like or opens a web page for displaying the screen 50 in a web browser, the controller 21 accepts a predetermined input. Upon accepting the predetermined input, the controller 21 transmits to the server 30 a degradation information request, which is a request to transmit the degradation information (S22). The controller 31 of the server 30 transmits information on a list of batteries 10 to the user terminal 20 (S23). At this time, the controller 31 of the server 30 may transmit, to the user terminal 20, a command to display the list of batteries 10 that can be viewed on the display device 25 of the user terminal 20. The controller 21 of the user terminal 20 displays the list of viewable batteries 10 on the display device 25. Then, a battery 10 selected by the user via the input unit 24 is identified (S24). The controller 21 of the user terminal 20 transmits information on the battery 10 selected by the user to the server 30 (S25). The controller 31 of the server 30 extracts the degradation information according to the information on the battery 10 selected by the user, and transmits the extracted degradation information to the user terminal 20 (S26). At this time, the controller 31 of the server 30 may transmit an instruction to display the degradation information on the display device 25 of the user terminal 20 to the user terminal 20. Then, the controller 21 of the user terminal 20 that has received the degradation information displays a screen according to the degradation information on the display device 25 (S27).

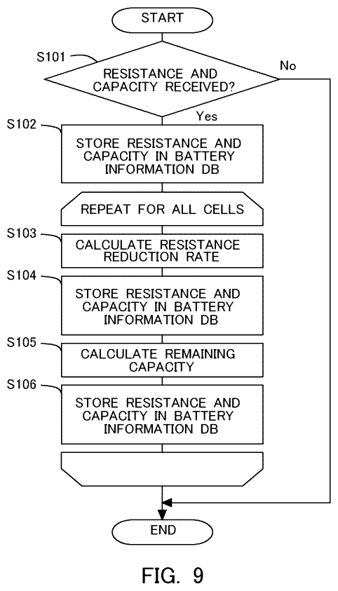

FIG. 9 is a flowchart illustrating a process in which the controller 31 of the server 30 collects battery information. The flowchart illustrated in FIG. 9 is executed by using as a trigger when the server 30 receives information on the resistance and capacity of the battery 10 from the diagnostic terminal 40.

In step S101, the controller 31 determines whether or not information (battery information) about the resistance and capacity of the battery 10 has been received from the diagnostic terminal 40. For example, the controller 31 determines whether or not the cell number, the location, the resistance, and the cell capacity corresponding to each cell are received together with the battery ID. Note that the diagnostic terminal 40 may transmit the resistance reduction rate instead of the resistance, or may transmit the remaining capacity instead of the capacity. When the controller 31 makes an affirmative determination in step S101, the process proceeds to step S102, whereas when the controller 31 makes a negative determination, the routine ends.

In step S102, the controller 31 stores the received battery information in the battery information DB 321. Note that the controller 31 may also receive information on the diagnostic terminal 40 together with the battery information, and store that information in the storage unit 32.

Next, the controller 31 repeatedly executes the processes of steps S103 to S106 described below for all the cells included in the battery 10. In step S103, the controller 31 calculates the resistance reduction rate of each cell. The controller 31 reads the reference value of the resistance of each cell from the storage unit 32 or obtains the reference value of the resistance of each cell from an external server. At this time, for example, the reference value of the resistance corresponding to the battery ID may be obtained. The reference value of the resistance may be a resistance at the time of a new product or a resistance at the time of certification. The controller 31 calculates a ratio of a reduced resistance value to the reference value of the resistance. The reduced resistance value is a value obtained by subtracting the resistance value at the time of diagnosis stored in the battery information DB 321 from the reference resistance value of the cell. When the process of step S103 is completed, then in step S104, the controller 31 stores information on the calculated resistance reduction rate in the resistance reduction rate field of the battery information DB 321.

In addition, in step S105, the controller 31 calculates the remaining capacities of the cells. The controller 31 reads the reference value of the cell capacity from the storage unit 32, or obtains the reference value of the cell capacity from an external server. At this time, for example, the reference value of the cell capacity corresponding to the battery ID may be obtained. The reference value of the cell capacity may be a cell capacity at the time of a new product or a cell capacity at the time of certification. The controller 31 calculates a ratio of the cell capacity at the time of diagnosis stored in the battery information DB 321 to the reference value of the cell capacity. When the process of step S105 is completed, then in step S106, the controller 31 stores information on the calculated remaining capacity in the remaining capacity field of the battery information DB 321.

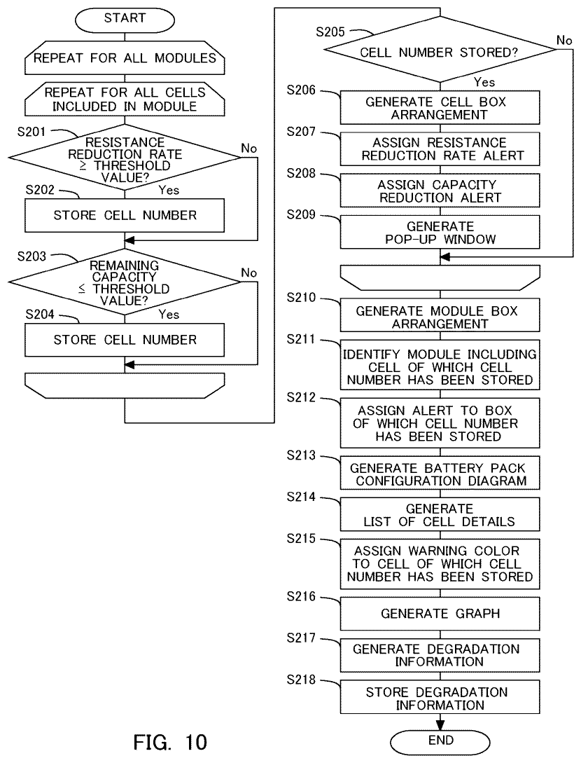

FIG. 10 is a flowchart illustrating a process in which the controller 31 of the server 30 generates degradation information according to the first embodiment. The flowchart illustrated in FIG. 10 may be executed in the server 30 by using as a trigger the completion of the process illustrated in FIG. 9, or may be executed by using as a trigger a request for the degradation information from the user terminal 20. Further, as another example, the flowchart illustrated in FIG. 10 may be executed at any timing after the process illustrated in FIG. 9 is completed in the server 30. The controller 31 repeatedly executes the processes from step S201 to step S209 for all the modules included in the battery 10. Also, the controller 31 repeatedly executes the processes from step S201 to step S204 for all the cells included in each module.

In step S201, the controller 31 determines whether or not the resistance reduction rate is equal to or greater than the resistance reduction rate threshold value. The resistance reduction rate threshold value is stored in the storage unit 32. When the controller 31 makes an affirmative determination in step S201, the process proceeds to step S202. In step S202, the controller 31 stores in the storage unit 32 the cell number of a cell of which the resistance reduction rate is equal to or greater than the resistance reduction rate threshold value. When the controller 31 makes a negative determination in step S201 or when the process of step S202 is completed, the process proceeds to step S203.

In step S203, the controller 31 determines whether or not the remaining capacity is equal to or less than the remaining capacity threshold value. The remaining capacity threshold value is stored in the storage unit 32. When the controller 31 makes an affirmative determination in step S203, the process proceeds to step S204. In step S204, the controller 31 stores in the storage unit 32 the cell number of a cell of which the remaining capacity is equal to or less than the remaining capacity threshold value. When the controller 31 makes a negative determination in step S203, or when the process of step S204 is completed, the process returns to step S201 or proceeds to step S205.

In step S205, the controller 31 determines whether or not the cell number of a cell of which the resistance reduction rate is equal to or greater than the resistance reduction rate reference value or the cell number of a cell of which the remaining capacity is equal to or less than the remaining capacity reference value is stored in the storage unit 32. That is, the controller 31 determines whether or not the cell number is stored in step S202 or step S204. When the controller 31 makes an affirmative determination in step S205, the process proceeds to step S206. In step S206, the controller 31 generates information on the arrangement of the cell boxes 526 when the pop-up window 525 is displayed on the screen 50. That is, information for displaying the number of cell boxes 526 corresponding to the number of cells in the pop-up window 525 is generated. The number of cells included in a module is equal to the number of times the processes of steps S201 to S204 are executed. The controller 31 counts the number of cells and generates the arrangement of the cell boxes 526 so that the cell boxes 526 are displayed corresponding to the number of cells.

When the processing in step S206 is completed, the process proceeds to step S207. In step S207, the controller 31 assigns a resistance reduction rate alert mark 527 to the cell box 526 of which the cell number has been stored in the storage unit 32 in step S202. Subsequently, in step S208, the controller 31 assigns a remaining power alert mark 528 to the cell box 526 of which the cell number has been stored in the storage unit 32 in step S204. Then, in step S209, the controller 31 generates a pop-up window 525 illustrated in FIG. 5. When the controller 31 makes a negative determination in step S205, or when the process of step S209 is completed, the process returns to step S201 or proceeds to step S210.

In step S210, the controller 31 generates information on the arrangement of the module boxes 521 to be displayed on the screen 50. That is, information for displaying the number of module boxes 521 corresponding to the modules on the screen 50 is generated. The number of modules is equal to the number of times the process of step S205 has been executed. The controller 31 counts the number of modules and generates the arrangement of the module boxes 521 so that the module boxes 521 are displayed corresponding to the number of modules.

In step S211, the controller 31 identifies a module including a cell of which the cell number has been stored in the storage unit 32 in step S202 or step S204. Further, in step S212, the controller 31 assigns an alert 524 to the module box 521 identified in step S211. Then, in step S213, the controller 31 generates the configuration diagram 52 of the battery pack illustrated in FIG. 4.

In addition, in step S214, the controller 31 generates the cell details illustrated in FIG. 6 according to the information stored in the battery information DB 321. Further, in step S215, the controller 31 assigns a warning color (e.g., red) to each cell of which the cell number has been stored in the storage unit 32 in step S202 or step S204 (see reference sign 601 in FIG. 6). The controller 31 assigns the warning color to the column of the resistance reduction rate for the cells stored in step S202, and assigns the warning color to the columns of the cell capacity, the residual capacity, and the variation for the cells stored in step S204. Further, in step S216, the controller 31 generates the graph illustrated in FIG. 7. The controller 31 counts the number of cells for each remaining capacity and generates the graph illustrated in FIG. 7.

In step S217, the controller 31 generates degradation information for displaying, on the display device 25 of the user terminal 20, the screen 50 illustrated in FIG. 4, the pop-up window 525 illustrated in FIG. 5, the screen 60 showing the details of the cells illustrated in FIG. 6, and the screen 70 showing the distribution of the remaining capacities of the respective cells illustrated in FIG. 7 as a graph. This degradation information may include a command for displaying each screen on the display device 25 and a command for displaying the pop-up window 525 in response to a warning module being clicked or moused over. Then, in step S218, the controller 31 stores the generated degradation information in the storage unit 32 in association with the battery ID.

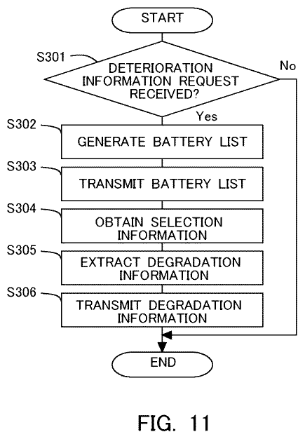

FIG. 11 is a flowchart illustrating a process in which the controller 31 of the server 30 provides degradation information to the user terminal 20. The flowchart illustrated in FIG. 11 is executed by using as a trigger the reception of a degradation information request from the user terminal 20. In step S301, the controller 31 determines whether or not a degradation information request has been received from the user terminal 20. When the controller 31 makes an affirmative determination in step S301, the process proceeds to step S302, whereas when the controller 31 makes a negative determination, the routine ends.

In step S302, the controller 31 generates a battery list. The battery list is information for presenting to the user batteries 10 for which degradation information can be provided. The controller 31 generates a list of the batteries 10 stored in the battery information DB 321. The controller 31 may generate the list of the batteries 10 so as to display information on the manufacturer, the model, the chemical composition, the battery ID, and the year and month of manufacture, of each battery 10 as displayed in the upper portion of the screen 50.

In step S303, the controller 31 transmits the battery list generated in step S301 to the user terminal 20. At this time, the controller 31 may transmit a command to display the battery list on the display device 25 of the user terminal 20.

In step S304, the controller 31 obtains, from the user terminal 20, information (selection information) about the battery 10 selected by the user from the battery list. In step S305, the controller 31 extracts the degradation information corresponding to the selection information from the degradation information stored in the storage unit 32. The controller 31 extracts the battery ID from the selection information, and extracts the degradation information corresponding to the battery ID from the storage unit 32.

In step S306, the controller 31 transmits the extracted degradation information to the user terminal 20. This degradation information includes a command for displaying each screen on the display device 25 and a command for displaying the pop-up window 525 in response to a warning module being clicked or moused over.

As described above, according to the present embodiment, the controller 31 can provide the user with information on the battery 10 so that the user can recognize the degradation state of the battery 10 at a glance. As a result, usability can be improved.

### Second Embodiment

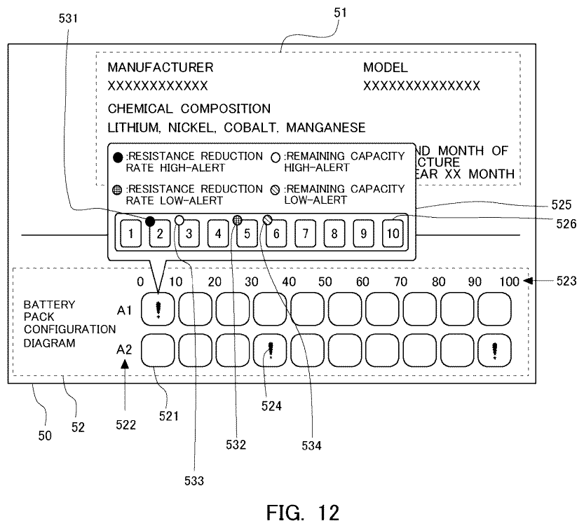

FIG. 12 is a view illustrating an example of a screen 50 when a pop-up window 525 is displayed in response to clicking or mouseover on a module box 521 according to a second embodiment. Differences of FIG. 12 from FIG. 5 will be mainly described. In the example illustrated in FIG. 12, a mark 531 corresponding to a high alert of the resistance reduction rate is displayed at a cell of which the resistance reduction rate is equal to or greater than a first resistance reduction rate threshold value; a mark 532 corresponding to a low alert of the resistance reduction rate is displayed at a cell of which the resistance reduction rate is equal to or greater than a second resistance reduction rate threshold value and less than the first resistance reduction rate threshold value; a mark 533 corresponding to a high alert of the remaining capacity is displayed at a cell of which the remaining capacity is equal to or less than a first remaining capacity threshold value; and a mark 534 corresponding to a low alert of the remaining capacity is displayed at a cell of which the remaining capacity is greater than the first remaining capacity threshold value and equal to or less than a second remaining capacity threshold value.

Here, the first resistance reduction rate threshold value may be the same value as the resistance reduction rate threshold value according to the first embodiment. In addition, the second resistance reduction rate threshold value is a value which is lower than the first resistance reduction rate threshold value and at which it is considered that the resistance reduction rate is large to a certain extent and it is preferable to warn the user. The second resistance reduction rate threshold value may be determined optionally. Also, the first remaining capacity threshold value may be the same value as the remaining capacity threshold value according to the first embodiment. Further, the second remaining capacity threshold value is a value which is higher than the first remaining capacity threshold value, and at which the remaining capacity is small to a certain extent and it is considered preferable to warn the user. The second remaining capacity threshold value may be determined optionally.

In this way, the controller 31 can warn of an increase in the resistance reduction rate and a reduction in the remaining capacity in a stepwise manner. That is, the controller 31 can execute at least one of outputting information for displaying a stepwise warning according to a reduction in resistance and outputting information for displaying a stepwise warning according to a reduction in capacity. Note that an increase in the resistance reduction rate may be considered more important, as an index of degradation of the battery 10, than a reduction in the remaining capacity, a warning that the resistance reduction rate is equal to or greater than the first resistance reduction rate threshold value may be displayed more prominently than a warning that the remaining capacity is equal to or less than the first remaining capacity threshold value. Further, the warning that the resistance reduction rate is equal to or greater than the second resistance reduction rate threshold value may be displayed more prominently than the warning that the remaining capacity is equal to or less than the second remaining capacity threshold value. In addition, the controller 31 may warn only the resistance reduction rate in a stepwise manner, and may warn the remaining capacity according to the remaining capacity threshold value in the same manner as in the first embodiment. As another example, the controller 31 may warn only the remaining capacity in a stepwise manner, and may warn the resistance reduction rate according to the resistance reduction rate threshold value as in the first embodiment. Also, the controller 31 may issue a warning in multiple steps according to a third threshold value of the resistance reduction rate and a third threshold value of the remaining capacity.

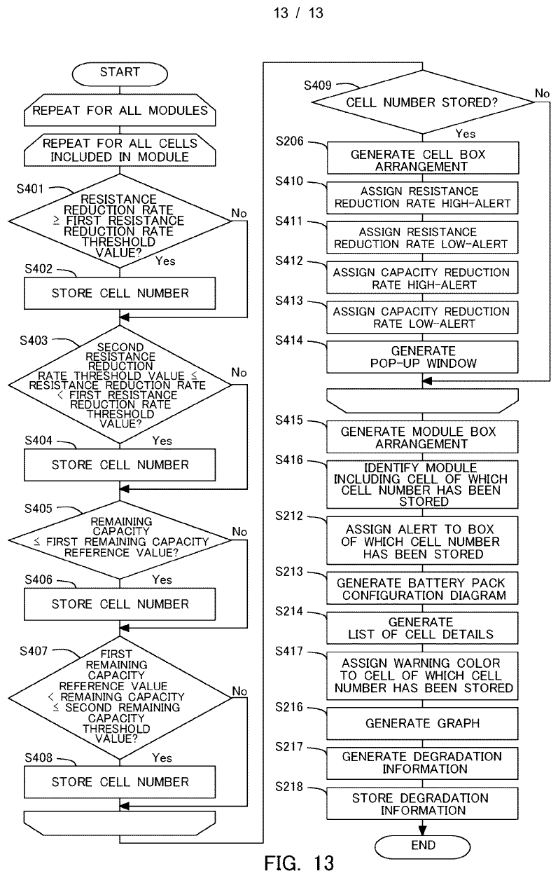

FIG. 13 is a flowchart illustrating a process in which the controller 31 of the server 30 according to the second embodiment generates degradation information. The flowchart illustrated in FIG. 13 may be executed in the server 30 by using as a trigger the completion of the process illustrated in FIG. 9, or may be executed by using as a trigger a request for the degradation information from the user terminal 20. Further, as another example, the flowchart illustrated in FIG. 13 may be executed at any timing after the process illustrated in FIG. 9 is completed in the server 30. The controller 31 repeatedly executes the processes from step S401 to step S414 for all the modules included in the battery 10. Also, the controller 31 repeatedly executes the processes from step S401 to step S408 for all the cells included in each module. Note that the same processes as those in the routine illustrated in FIG. 10 are denoted by the same reference signs, and description thereof will be omitted. Also, in the second embodiment, the controller 31 separately executes the process illustrated in FIG. 9 and the process illustrated in FIG. 11.

In step S401, the controller 31 determines whether or not the resistance reduction rate is equal to or greater than the first resistance reduction rate threshold value. The first resistance reduction rate threshold value is stored in the storage unit 32. When the controller 31 makes an affirmative determination in step S401, the process proceeds to step S402. In step S402, the controller 31 stores in the storage unit 32 the cell number of a cell of which the resistance reduction rate is equal to or greater than the first resistance reduction rate threshold value. When the controller 31 makes a negative determination in step S401 or when the process of step S402 is completed, the process proceeds to step S403.

In step S403, the controller 31 determines whether or not the resistance reduction rate is equal to or greater than the second resistance reduction rate threshold value and less than the first resistance reduction rate threshold value. The second resistance reduction rate threshold value is stored in the storage unit 32. When the controller 31 makes an affirmative determination in step S403, the process proceeds to step S404. In step S404, the controller 31 stores in the storage unit 32 the cell number of a cell of which the resistance reduction rate is equal to or greater than the second resistance reduction rate threshold value and less than the first resistance reduction rate threshold value. When the controller 31 makes a negative determination in step S403 or when the process of step S404 is completed, the process proceeds to step S405.

In step S405, the controller 31 determines whether or not the remaining capacity is equal to or less than the first remaining capacity reference value. The first remaining capacity threshold value is stored in the storage unit 32. When the controller 31 makes an affirmative determination in step S405, the process proceeds to step S406. In step S406, the controller 31 stores in the storage unit 32 the cell number of a cell of which the remaining capacity is equal to or less than the first remaining capacity threshold value. When the controller 31 makes a negative determination in step S405 or when the process of step S406 is completed, the process proceeds to step S407.

In step S407, the controller 31 determines whether or not the remaining capacity is higher than the first remaining capacity threshold value and is less than the second remaining capacity threshold value. The second remaining capacity threshold value is stored in the storage unit 32. When the controller 31 makes an affirmative determination in step S407, the process proceeds to step S408. In step S408, the controller 31 stores in the storage unit 32 the cell number of a cell of which the remaining capacity is higher than the first remaining capacity threshold value and less than the second remaining capacity threshold value. When the controller 31 makes a negative determination in step S407, or when the process of step S408 is completed, the process returns to step S401 or proceeds to step S409.

In step S409, the controller 31 determines whether or not a cell number has been stored in step S402, step S404, step S406, or step S408. When the controller 31 makes an affirmative determination in step S409, the process proceeds to step S206, and the controller 31 generates an arrangement of the cell boxes 526. When the process in step S206 is completed, the process proceeds to step S410.

In step S410, the controller 31 assigns a resistance reduction rate high-alert mark 531 to the cell box 526 of which the cell number has been stored in the storage unit 32 in step S402. In step S411, the controller 31 assigns a resistance reduction rate low-alert mark 532 to the cell box 526 of which the cell number has been stored in the storage unit 32 in step S404. In step S412, the controller 31 assigns a remaining capacity high-alert mark 533 to the cell box 526 of which the cell number has been stored in the storage unit 32 in step S406. In step S413, the controller 31 assigns a remaining capacity low-alert mark 534 to the cell box 526 of which the cell number has been stored in the storage unit 32 in step S408. Then, in step S414, the controller 31 generates a pop-up window 525 illustrated in FIG. 12. When the controller 31 makes a negative determination in step S409, or when the process of step S414 is completed, the process returns to step S401 or proceeds to step S415.

In step S415, the controller 31 generates information on the arrangement of the module boxes 521 to be displayed on the screen 50. That is, information for displaying the number of module boxes 521 corresponding to the modules on the screen 50 is generated. The number of modules is equal to the number of times the process of step S409 has been executed. The controller 31 counts the number of modules, and generates information on the arrangement of the module boxes 521 so that the module boxes 521 are displayed corresponding to the number of modules.

In step S416, the controller 31 identifies a module including a cell of which the cell number has been stored in the storage unit 32 in step S402, S404, S406, or S408. When the process of step S416 is completed, the process proceeds to step S212. Further, when the process of step S214 is completed, the process proceeds to step S417.

In step S417, the controller 31 assigns a warning color (e.g., red) to each cell of which the cell number has been stored in the storage unit 32 in step S402, S404, S406, or S408 (see reference sign 601 in FIG. 6). The controller 31 assigns the warning color to the column of the resistance reduction rate for the cells stored in step S402 or S404, and assigns the warning color to the columns of the cell capacity, the residual capacity, and the variation for the cells stored in step S406 or S408. Note that the warning color may correspond to the color of each alert mark. When the process of step S417 is completed, the process proceeds to step S216.

As described above, according to the present embodiment, the controller 31 can provide the user with the state of degradation of the battery 10 in a stepwise manner. As a result, usability can be improved.

### Other Embodiments

The above-described embodiments are merely examples, and the present invention can be appropriately modified and implemented within a range not departing from the gist thereof. The processes and/or means (devices, units, etc.) described in the present disclosure can be freely combined and implemented as long as no technical contradiction occurs. In addition, the processes described as being performed by one device or unit may be shared and performed by a plurality of devices or units. Alternatively, the processes described as being performed by different devices or units may be performed by a single device or unit. In a computer system, it is possible to flexibly change the hardware configuration (server configuration) that can achieve each function of the computer system. For example, the diagnostic terminal 40 may have the functions of the server 30.

In the above-described embodiments, the controller 31 of the server 30 obtains the resistance and the capacity from the diagnostic terminal 40 on a cell basis, but as another example, the controller 31 may obtain the resistance and the capacity on a module basis. In this case, the controller 31 generates the configuration diagram 52 of the battery pack without generating the pop-up window 525. In addition, the controller 31 does not generate the screen 60 and the screen 70.

In the above-described embodiments, the resistance and the capacity are detected in the diagnostic terminal 40 or the server 30, but as another example, the resistance and the capacity may be detected in a vehicle in which the battery 10 is installed, and the values detected may be transmitted from the vehicle to the server 30. For example, a resistance measuring sensor may be attached to each cell or module of the battery 10 to measure the resistance value in the vehicle. In addition, for example, the vehicle can obtain parameters capable of estimating the SOH for each cell, module, or pack, so that the SOH may be detected in the vehicle and transmitted from the vehicle to the server 30. When the vehicle transmits data to the server 30, data associated with the battery ID may be transmitted.

The present invention can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. A system comprising:
a diagnostic terminal configured to detect, by a sensor, information on degradation corresponding to at least one of a unit of cell or a unit of module of a battery pack;
a server including a controller configured to output information for displaying diagnostic information according to the information on the degradation; and
a user terminal;
wherein the diagnostic terminal transmits the information on the degradation to the server;
the controller is configured to perform:
receiving the information on the degradation from the diagnostic terminal; and
transmitting, to the user terminal, a command to display diagnostic information of the module according to the information on the degradation, for display corresponding to the pack and the module; and
in response to the command received from the server, the user terminal displays, on a display device, the diagnostic information of the module according to the information on the degradation, for display corresponding to the pack and the module.

2. An information processing apparatus comprising a controller configured to perform:
obtaining information on degradation corresponding to at least one of a unit of cell or a unit of module of a battery pack; and
outputting information for displaying diagnostic information of the module according to the information on the degradation, for display corresponding to the pack and the module.

3. The information processing apparatus according to claim 2, wherein the information on the degradation includes information on a resistance detected when the cell or the module is energized at a predetermined frequency.

4. The information processing apparatus according to claim 2, wherein the information on the degradation includes information on a capacity of the cell or the module.

5. The information processing apparatus according to claim 2, wherein
the information on the degradation includes information on a resistance detected when the cell or the module is energized at a predetermined frequency and information on a capacity of the cell or the module; and
the controller outputs information for displaying a warning corresponding to the information on the resistance and a warning corresponding to the information on the capacity, in different display modes.

6. The information processing apparatus according to claim 5, wherein the controller outputs information to be displayed in such a manner that the warning corresponding to the information on the resistance has a higher degree of warning than the warning corresponding to the information on the capacity.

7. The information processing apparatus according to claim 2, wherein
the information on the degradation includes information on a resistance detected when the cell or the module is energized at a predetermined frequency and information on a capacity of the cell or the module; and
the controller performs:
outputting information for displaying at least one of a warning corresponding to the information on the resistance and a warning corresponding to the information on the capacity; and
outputting at least one of information for displaying a stepwise warning according to a reduction in the resistance in the warning corresponding to the information on the resistance or information for displaying a stepwise warning according to a decrease in the capacity in the warning corresponding to the information on the capacity.

8. The information processing apparatus according to claim 2, wherein
the information on the degradation includes information on degradation corresponding to a unit of cells of the pack; and
the controller further outputs information for displaying diagnostic information of each of a plurality of the cells included in the module selected, for display corresponding to the pack and the module.

9. An information processing method for causing a computer to perform:
obtaining information on degradation corresponding to at least one of a unit of cell or a unit of module of a battery pack; and
outputting information for displaying diagnostic information of the module according to the information on the degradation, for display corresponding to the pack and the module.

10. The information processing method according to claim 9, wherein
the information on the degradation includes information on a resistance detected when the cell or the module is energized at a predetermined frequency.

11. The information processing method according to claim 9, wherein
the information on the degradation may include information on a capacity of the cell or the module.

12. The information processing method according to claim 9, wherein
the information on the degradation includes information on a resistance detected when the cell or the module is energized at a predetermined frequency and information on a capacity of the cell or the module; and
the computer outputs information for displaying a warning corresponding to the information on the resistance and a warning corresponding to the information on the capacity, in different display modes.

13. The information processing method according to claim 12, wherein the computer outputs information to be displayed in such a manner that the warning corresponding to the information on the resistance has a higher degree of warning than the warning corresponding to the information on the capacity.

14. The information processing method according to claim 9, wherein
the information on the degradation includes information on a resistance detected when the cell or the module is energized at a predetermined frequency and information on a capacity of the cell or the module; and
the computer performs:
outputting information for displaying at least one of a warning corresponding to the information on the resistance and a warning corresponding to the information on the capacity; and
outputting at least one of information for displaying a stepwise warning according to a reduction in the resistance in the warning corresponding to the information on the resistance or information for displaying a stepwise warning according to a decrease in the capacity in the warning corresponding to the information on the capacity.

15. The information processing method according to claim 9, wherein
the information on the degradation includes information on degradation corresponding to a unit of cells of the pack; and
the computer further outputs information for displaying diagnostic information of each of a plurality of the cells included in the module selected, for display corresponding to the pack and the module.
